(19) United States
(12) Patent Application Publication
(10) Pub. No.: US 2003/0234914 A1
(43) Pub. Date: Dec. 25, 2003

(54) Autostereoscopic performance wand display system

(76) Inventor: Dennis J. Solomon, Yarmouth Port, MA (US)

Correspondence Address: Dennis J. Solomon, P.O. Box 289, Yarmouth Port, MA, 02675, US

(21) Appl. No.: 10/385,349

(22) Filed: Mar. 10, 2003

Related U.S. Application Data
(63) Continuation-in-part of application No. 09/793,811, filed on Feb. 24, 2001, now abandoned.
(60) Provisional application No. 60/212,315, filed on Jun. 16, 2000.

(51) Int. Cl. G03B 21/00

(52) U.S. Cl. 353/122

(57) ABSTRACT

A simplified performance wand display system with an illuminated wand display and having other modalities such as audio and tactile is disclosed. The display utilizes the persistence of vision approach and presents a series of dynamic images and text on each cycle. Programming images and sounds may be controlled by external sources including projectors and Internet displays. Each wand may be assigned an identity at performance time based on its current location. A strategy and physical game model is presented. Applications include promotions, toys, games, gifts and related novelties.

This present application is a continuation of provisional patent applications 60/212,315, 60/212,315 and continuation-in-part of U.S. patent application Ser. No. 09/793,811.

### DESCRIPTION

1. Technical Field

This invention relates generally to display devices and more particularly to autostereoscopic imaging displays.

2. Background Art

The participation of the audience as an active part of a computerized special effect has never been perfected and the concept itself is a recent phenomenon. A few inventions have been proposed which have generally been too complicated to be reliable, expensive to manufacture, without sufficient resolution, or sufficient stability to gain any acceptance. None have combined a directional projector and an active, responsive display wand in the control of each member of the audience.

In contrast, the presentation of visual images by moving display elements has a long and crowded history. Following the development of light emitting diodes (LEDs), a large variety of displays, games, wands and yo-yos have been manufactured, publicly presented and patented. These inventions strobe arrays of individual light elements or pixels as the array is displaced cyclically, producing an image or pattern due to the persistence phenomenon of human vision. Francis Duffy in his U.S. Pat. No. 3,958,235 discloses linear wand of LEDs oscillated by a door buzzer electromagnetic actuator. He specifically indicated that a manual actuator may be used. Edwin Berlin in his U.S. Pat. No. 4,160,973 extended the work of Duffy to both 2 & 3 devices using “rotational” or “short-distance oscillatory motion” with extensions of Nipkow's disc television. Berlin also disclosed the use of moving digital memory and electronics and a “single pulse (per cycle) which adjusts the frequency of a clock (controlling the timing of each LED)”. Bill Bell is his U.S. Pat. No. 4,470,044 disclosed a single stationary array of LEDs with “saccadic eye movement” timing with non-claimed references to applications including wands, tops and bicycles.

Marhan Reysman in his U.S. Pat. No. 4,552,542 discloses a spinning disc toy with a centrifugal switch causing a light to be illuminated. It follows a line of inventions related to tops and yo-yos. Hiner is his U.S. Pat. No. 4,080,753 discloses a toy flying saucer with a centrifugal motion sensor.

The techniques of Duffy, Berlin & Bell were applied to handheld wands differentiated from the prior art by the detailed centrifugal switch design. Tokimoto is his U.S. Pat. No. 5,406,300 discloses a display wand with a Hall effect acceleration sensor. Sako in his U.S. Pat. No. 5,444,456 uses an inertial sensor having “a pair of fixed contacts and a moveable contact” to adjust the clock of the display electronics. While inventive and functional, the Sako design remains awkward and requires considerable energy to maintain an image. For these reasons, it is unsuitable for entertainment, marketing and game applications.

At many events from the mid-1980s, these and simpler visual and audio producing items have been combined with non-directional, wireless signals to produce a global special effects. As disclosed in Bell's U.S. Pat. No. 4,470,044, these technologies may be affixed to bicycles and motorized vehicles, to clothing, wands, yo-yos and other accessories.

Additionally, wireless technologies have been applied to visual and audio producing proximity devices such as dance floors—U.S. Pat. No. 5,558,654, pagers—U.S. Pat. No. 3,865,001, top hats—U.S. Pat. No. 3,749,810, and clothing—U.S. Pat. No. 5,461,188 to produce a global synchrony and pre-programmed or transferred effects.

None of these or the other prior art has successfully addressed the problem of providing low cost, real-time, precision control of audio or visual effects such that an affordable uniform appliance distributed, affixed, attached, accompanying or held by each member of an audience or group would seamlessly, and without error, integrate in a global screen or orchestra in real-time.

A number of other problems have remained including the development of switching methodology which permits a static on-off state, display freedom from inertial changes and a frame of reference to global orientation.

This inventor has a long history of invention in these relative fields of persistence of vision, three dimensional and professional stage, film and event special effects. His U.S. Pat. No. 4,983,031 (1990) discloses a method of data display control and method for the proper display of images to all observers in both directions for projection and LED moving displays—technologies chosen by the U.S. Department of Defense for advanced airspace control. His U.S. Pat. No. 4,777,568 (1988) and U.S. Pat. No. 4,729,071 (1987) disclose a high speed, low inertial stage scanning system—currently in use by major international touring music and theatre acts. In part, both are related precursors to the present invention

### SUMMARY OF THE INVENTION

The present invention discloses an improved method and device for the low cost, real-time, precision control of audio or visual effects such that an affordable uniform appliance distributed, affixed, attached, accompanying or held by each member of an audience or group would seamlessly, and without error, integrate in a global screen or orchestra in real-time.

Additionally, an object of the invention is an improved motion switching method for the display wand including a frame of reference to global orientation.

Another object of the invention is a reduction in the cost and energy required to operate the performance display wand system.

A further object is the application of the method of the present invention to promotional and entertainment devices and games.

Another object is the application of the method to artistic presentations,

Another object is the application of the method to autostereoscopic presentations,

Another object of this invention to provide a game method that enhances hand-eye coordination and other skills,

The above and still further objects, features and advantages of the present invention will become apparent upon consideration of the following detailed disclosure of specific embodiments of the invention, especially when taken in conjunction with the accompanying drawings, wherein:

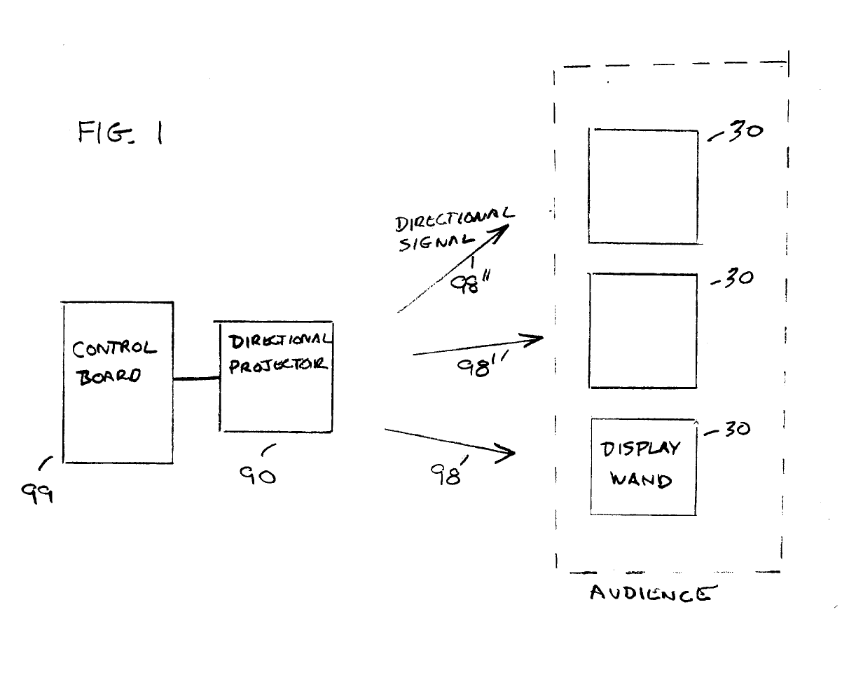

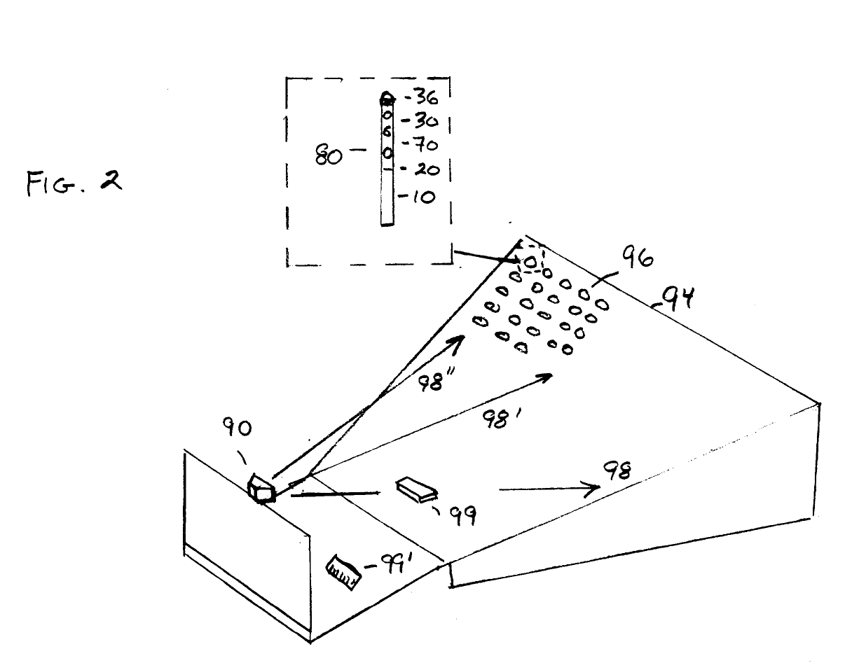

FIG. 1 presents a block diagram of the performance wand display system.

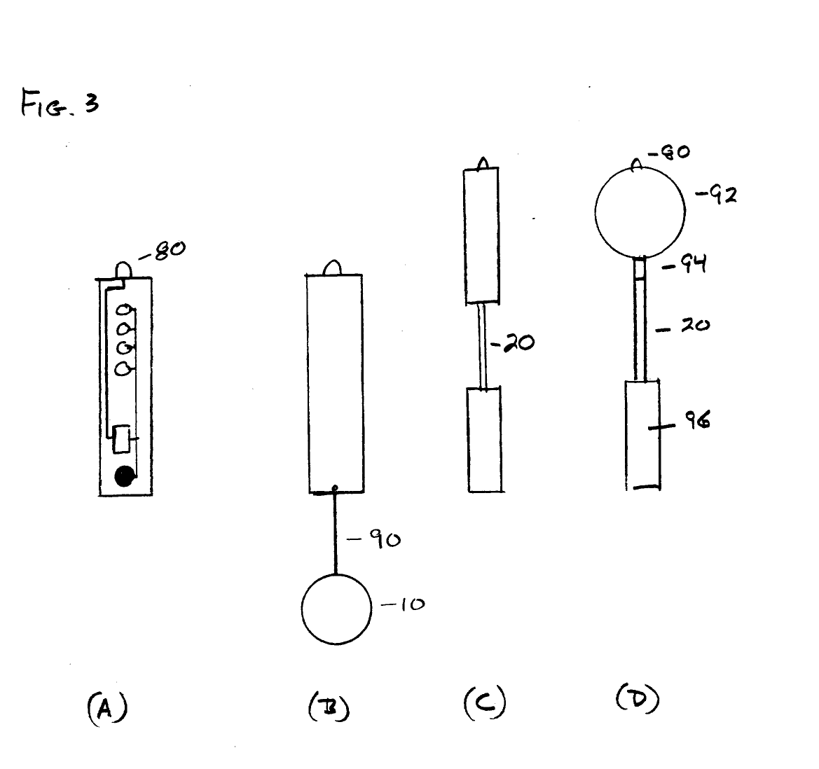

FIG. 2 presents a perspective view of the performance wand display system.

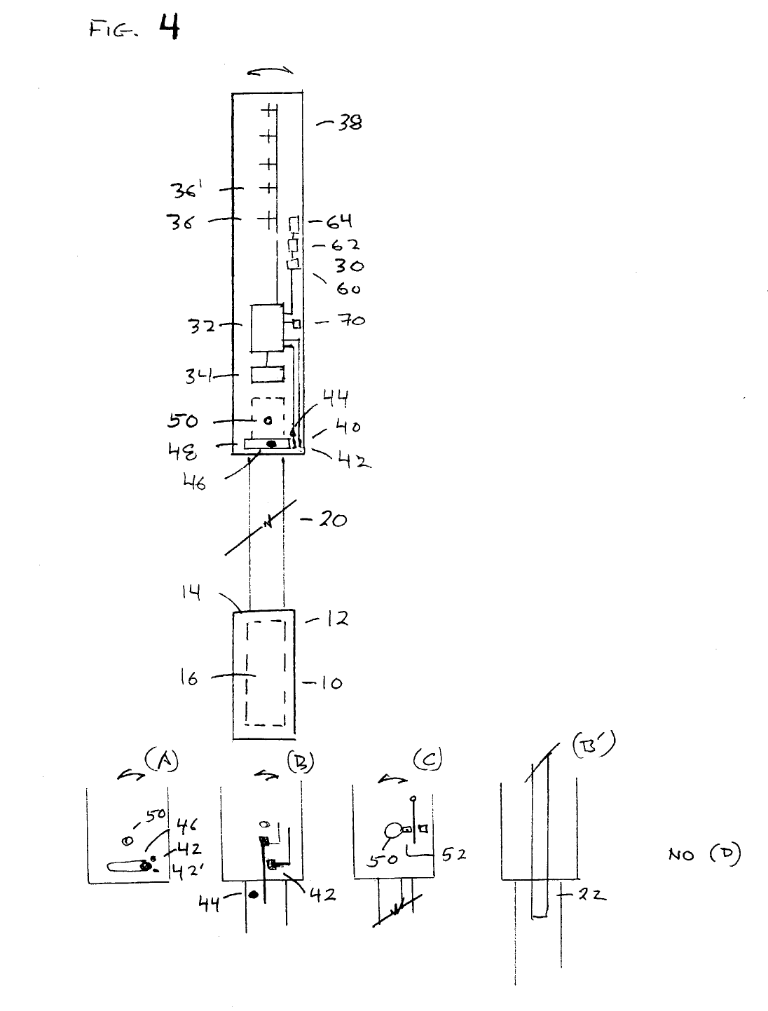

FIG. 3 presents a cross section of a simplified performance display wand.

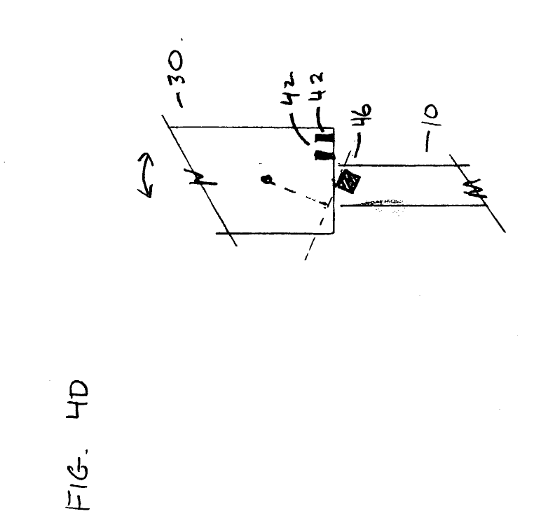

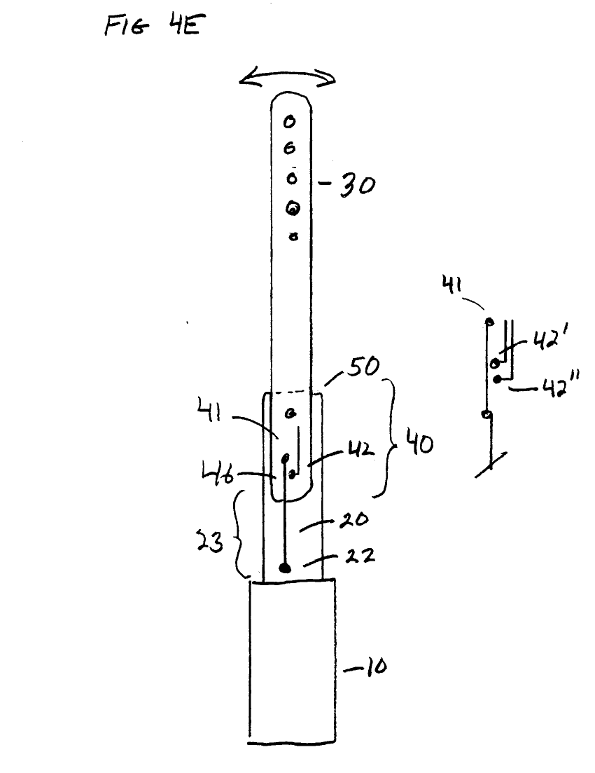

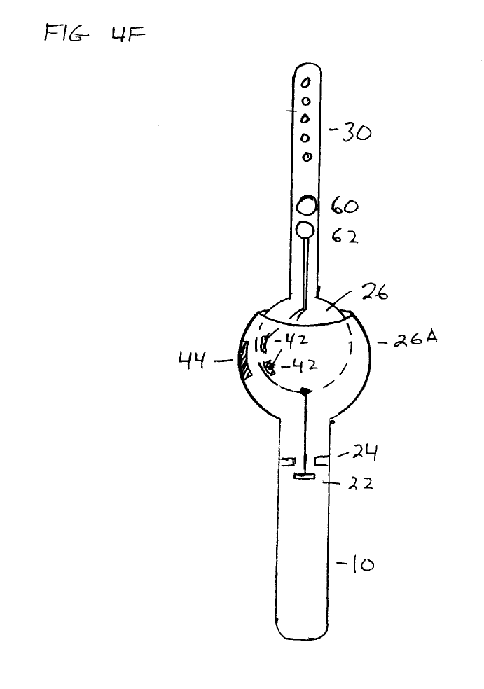

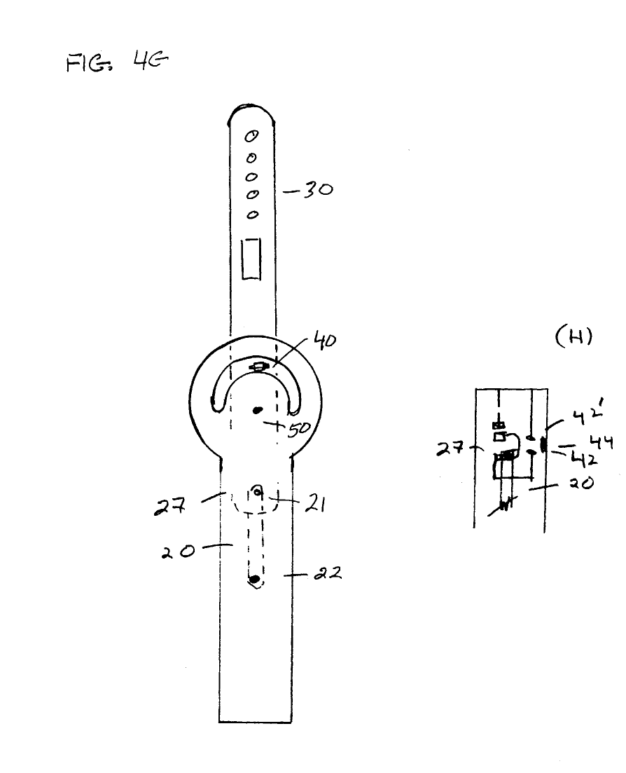

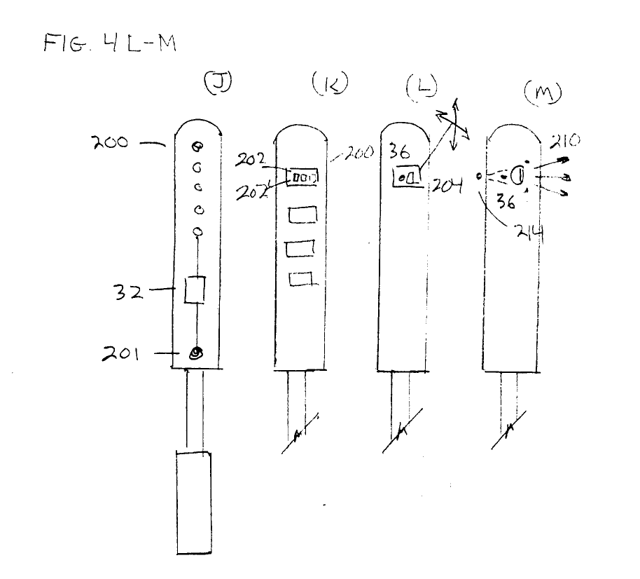

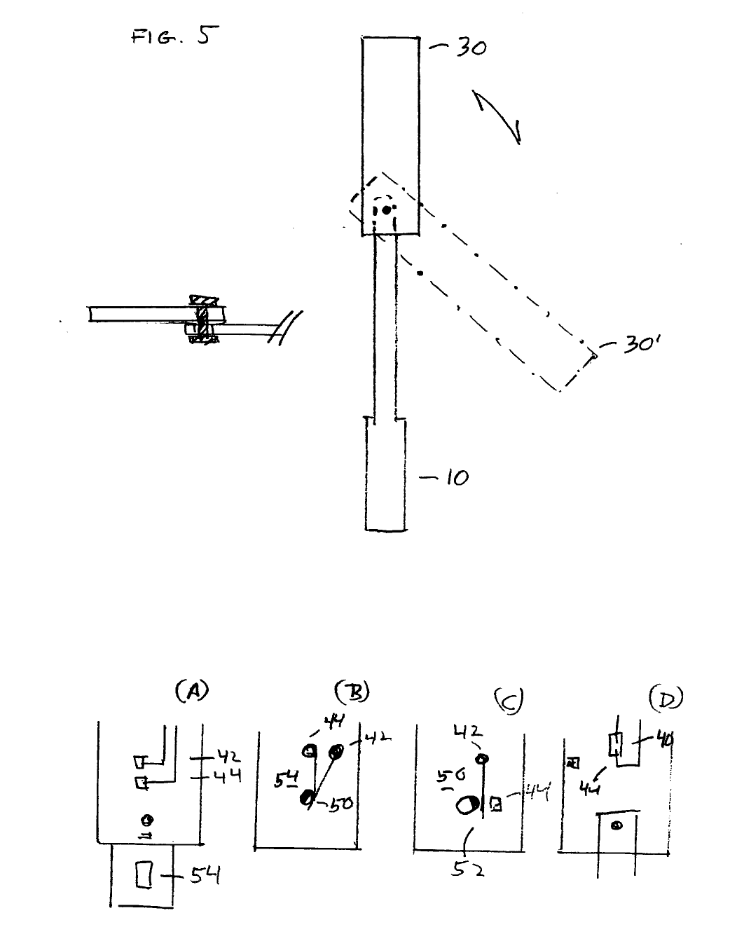

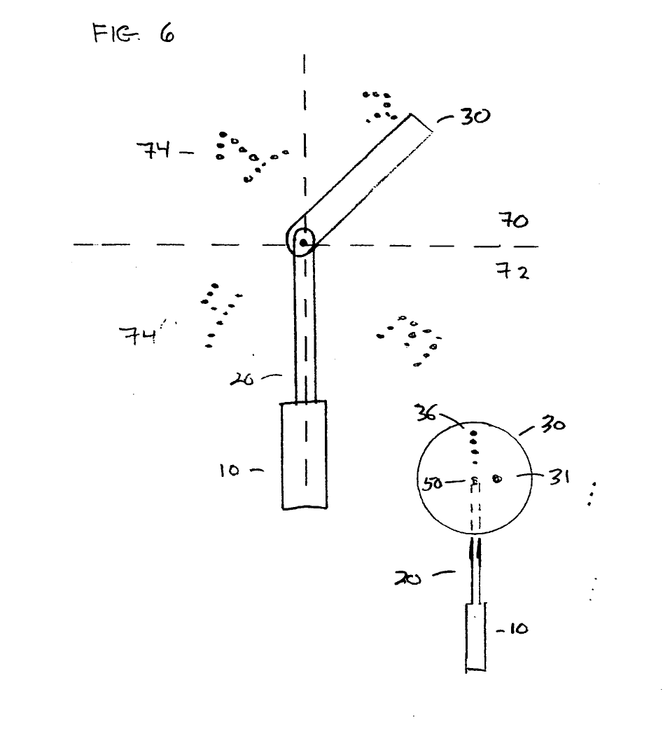

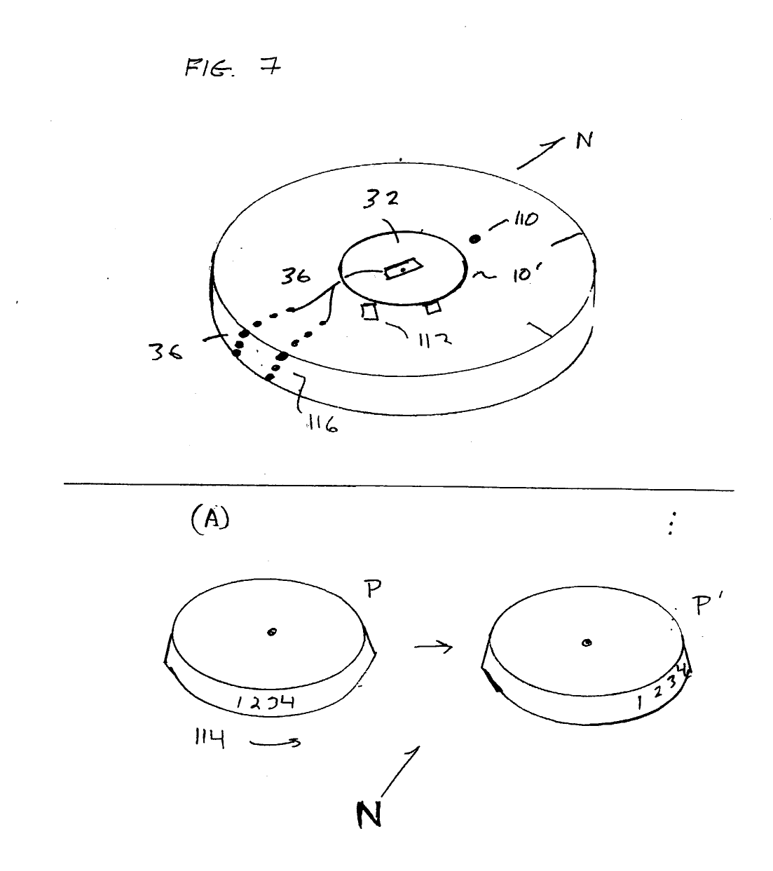

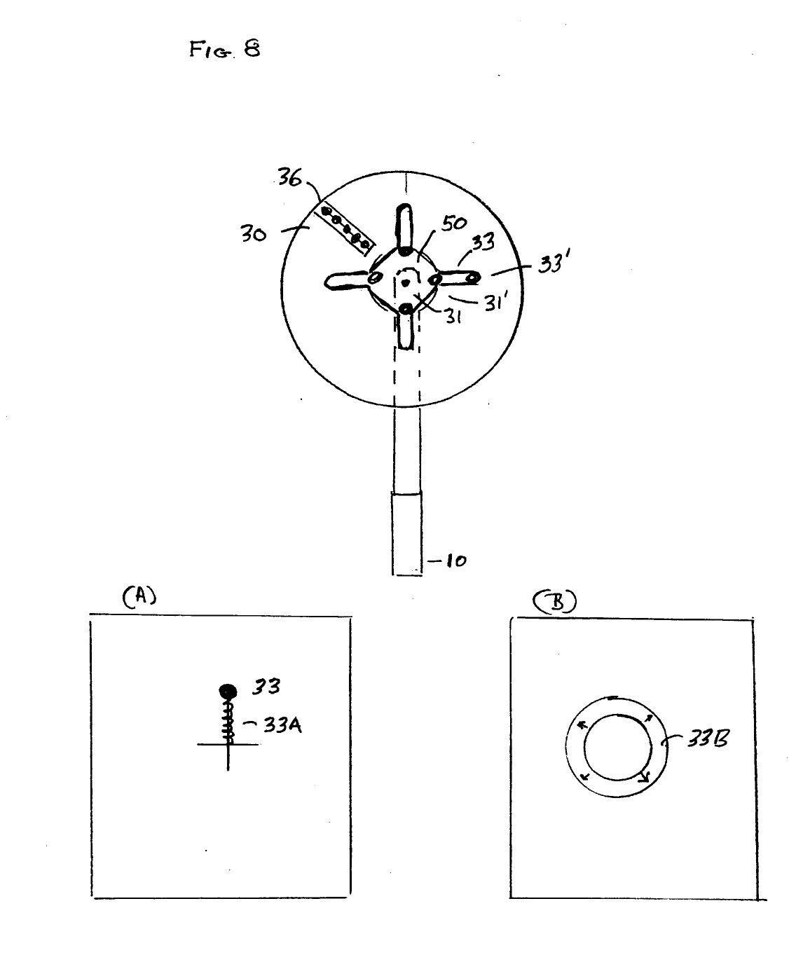

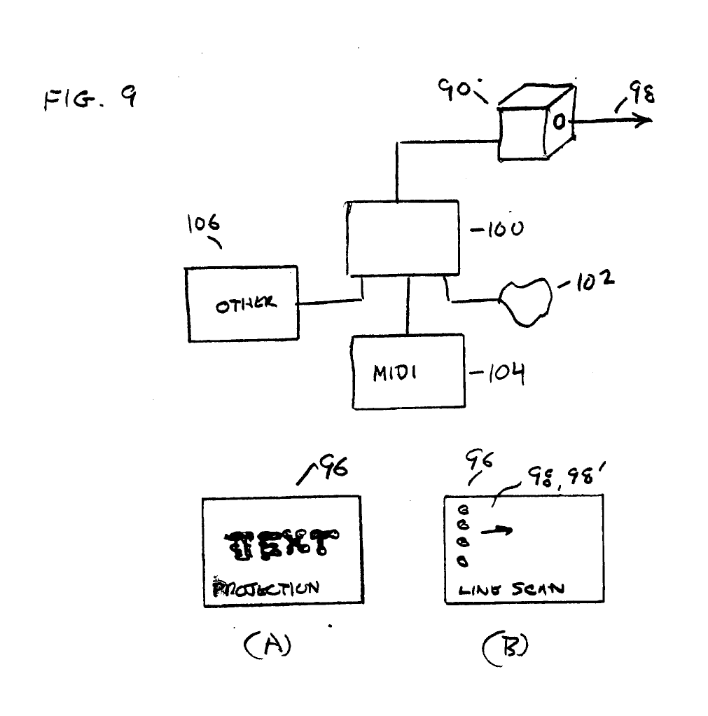

FIGS. 4a-m presents the different motion switch constructions of the display wand.

FIG. 5 presents a cross section of a rotating embodiment of the advanced display wand.

FIGS. 5a-d presents switch constructions of the display wand.

FIG. 6 presents a programming result of the display wand.

FIG. 6a presents the positions of the center of gravity of the display wand.

FIG. 7 presents a flying disk embodiment of the display wand.

FIG. 8 presents a centrifugal energy storage system of the display wand.

FIG. 9 presents a conceptual structure the projector of the system.

FIG. 10 presents a conceptual structure the keyboard controller of the system.

FIG. 11 presents a partial schematic diagram of projector-receiver trigger system-modulated.

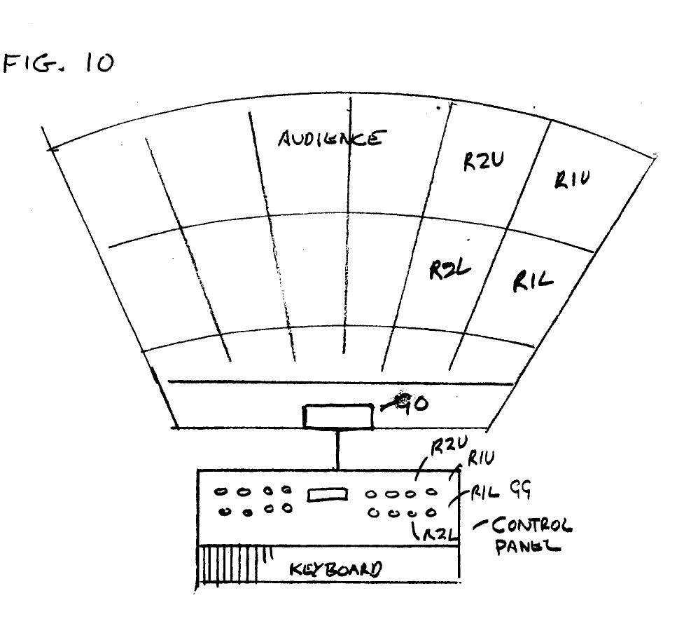

FIG. 12 presents a partial schematic diagram of projector-receiver trigger system-chromatic.

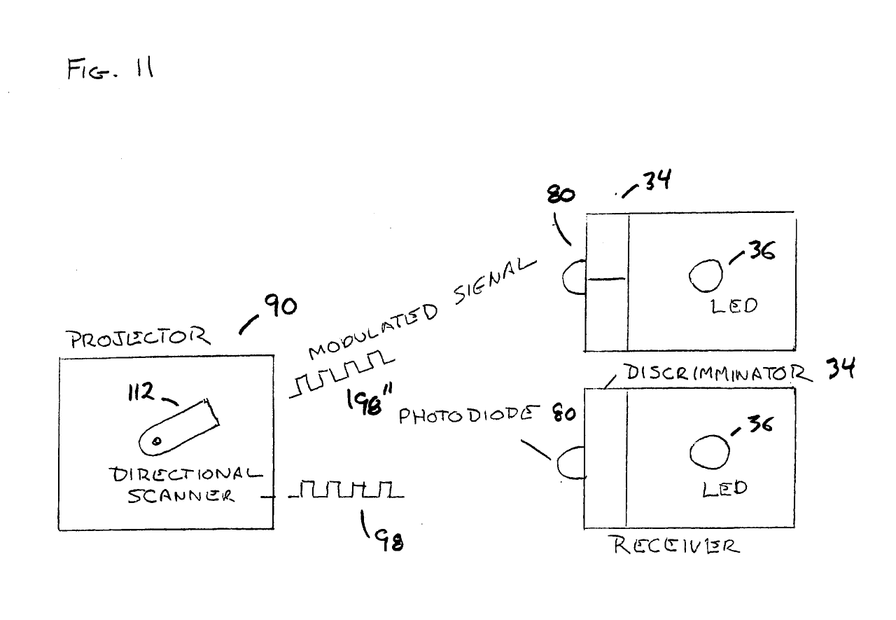

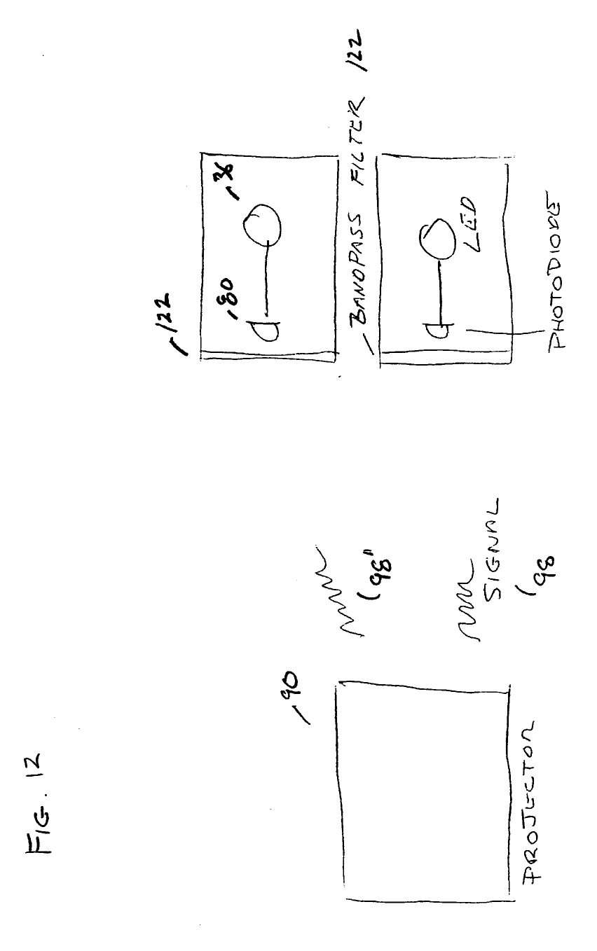

FIG. 13 presents a block diagram of projector-receiver ID trigger system.

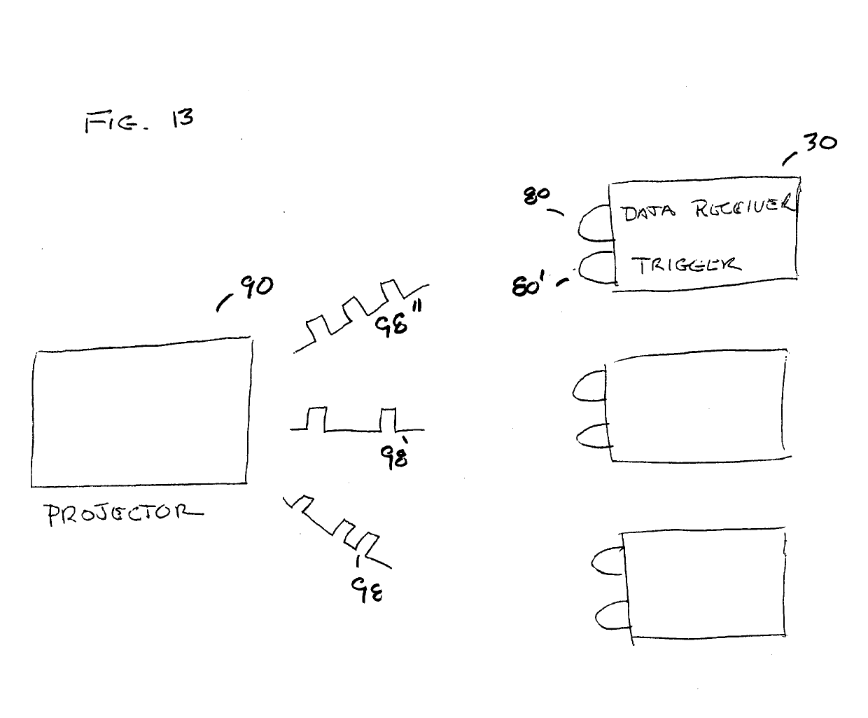

FIG. 14 presents a perspective view of an image projector.

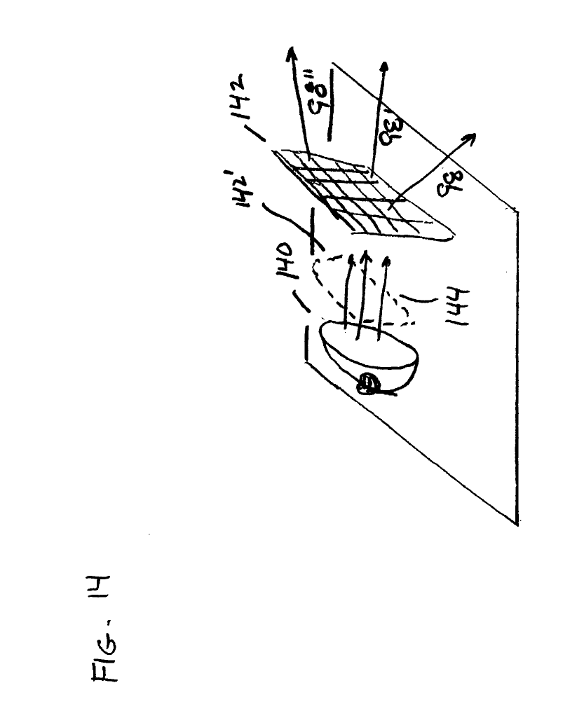

FIG. 15 presents a perspective view of a scanning projector.

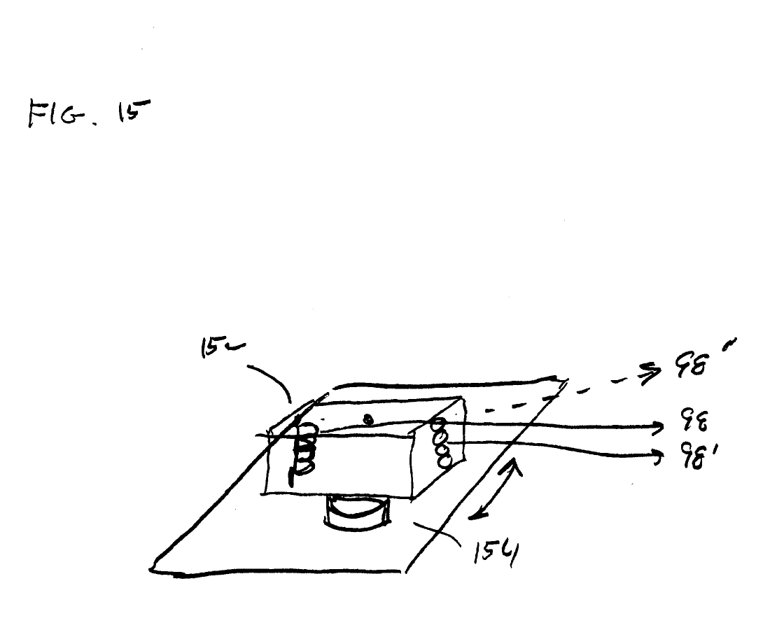

FIG. 16 presents a block diagram of a game embodiment of the present invention

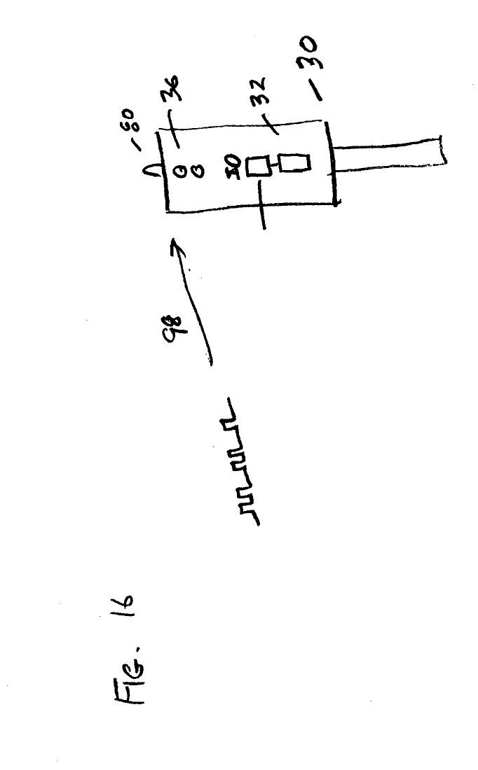

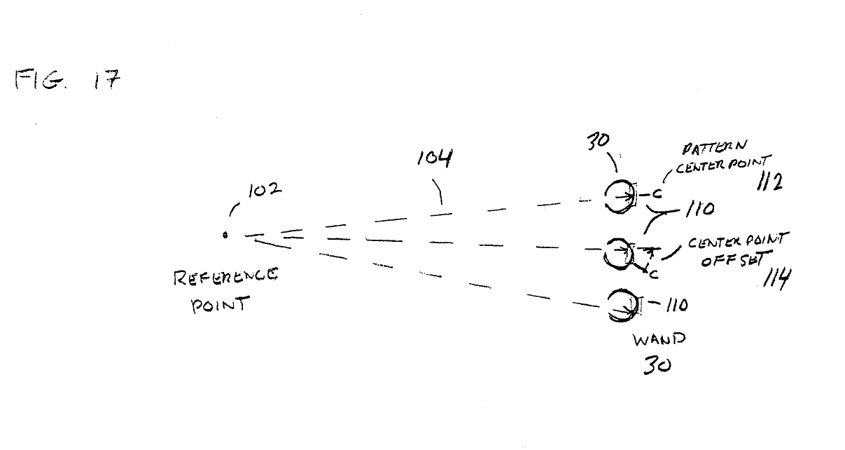

FIG. 17 presents a top diagram of an autostercoscopic embodiment of the present invention

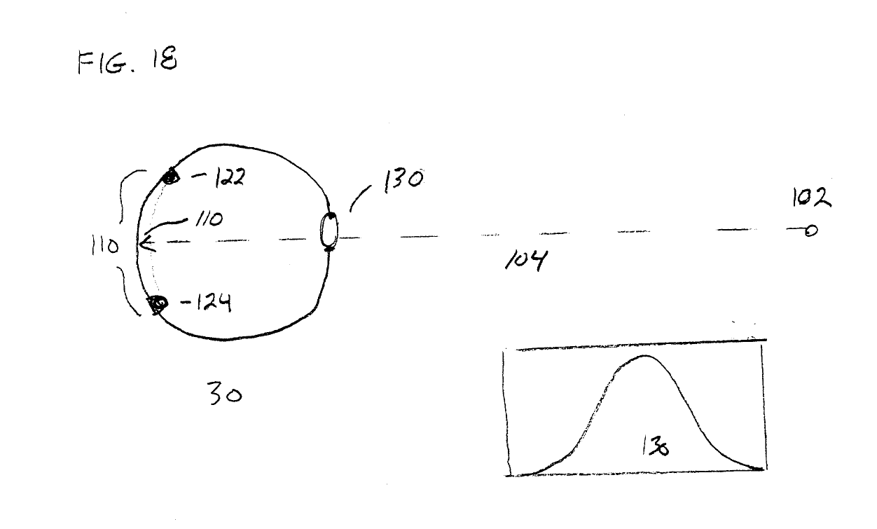

FIG. 18 presents a top view of the wand autostereoscopic embodiment of the present invention

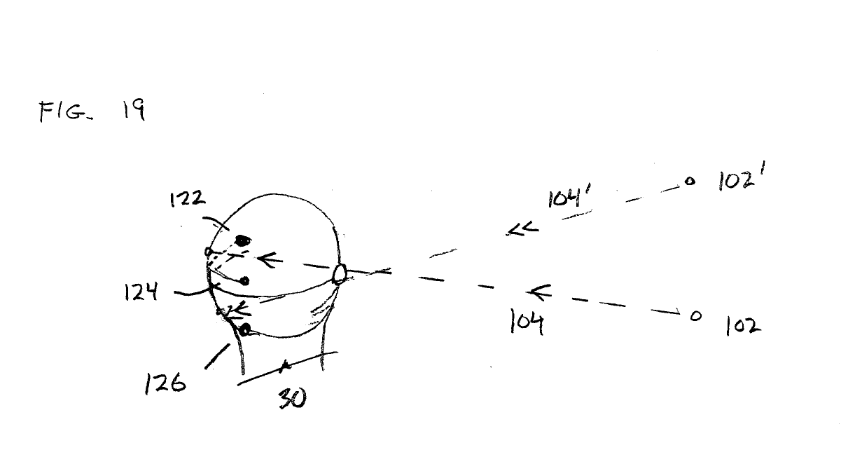

FIG. 19 presents a perspective view of the three detector autostereoscopic embodiment of the present invention

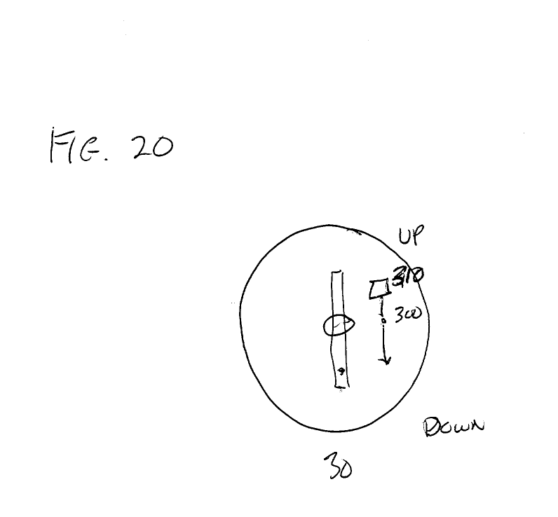

FIG. 20 presents a global orientation autostercoscopic embodiment of the present invention

### DETAILED DESCRIPTION OF THE INVENTION

The performance wand display system is designed to provide a novel visual and auditory experience and artistic medium for artistic, promotional, educational, entertainment and other assemblies. An example of a novel application would be to distribute a performance wand display in the form of a pennant to each fan at a night sporting event such as Monday Night Football. During halftime, or in response to a touchdown or other memorable incident, the show director, by employing the projector-receiver system, could orchestrate in real-time, precise explosions of light and sound throughout the audience including the display of text and graphics visible across the breath of the stadium. Each member of the audience becomes a pixel in a gigantic screen, and a voice in a gigantic chorus.

Utilizing the novel features disclosed in the present invention, the visual and audio response is precise and independent of the dynamic location of the member of the audience or display wand. Further, as a further benefit of the novel features and combinations of the present invention, the cost of implementing the method of the present invention is substantially less than other approaches and for the first time, practical and competitive in the marketplace. The performance wand display system may be employed at any assembly, large or small, or applied to any structure. Also, the wand display may be incorporate a message, song or game, and continue to operate after or independent of a performance or assembly.

Although the term performance wand is used to describe the simple and autostereoscopic effects module, it may be understood that the module or wand may take any shape or be incorporated into any independent handheld, worn, or positioned effects device including but not limited to tickets, badges, buttons, globes, cylinders, signs, sashes, headdresses and emblems affixed to any object, moveable or stationary.

FIG. 1 presents a block diagram of the principal components of the performance wand display system including the control board or program storage medium 99, the directional projector 90, the directional signals 98, 98′, 98″, and a multiplicity of the receivers or wand displays 30.

FIG. 2 presents a perspective view of the present invention including a illuminated wand 30 with some or all of the elements of the wand of FIG. 1, having one or more light emitting elements 36, a connecting member 20, handle 10 and an active receiver 80 capable of receiving optical or acoustic signals.

In operation, the show director at the control board 99 or instrument 99′ sends a sequence of commands, live or from a stored visual or audio program, to the projector 90 which emits a precisely timed series of directional signals 98, 98′, 98″ programmed to activate the wand displays 30 at a precise location. In its simplest embodiment, the projector 90 displays an image at a specific wavelength on the audience which causes the wavelength-specific wand display trigger to activate. The projector 90 may also transmit a program sequence for later execution and display. Each wand may contain a unique encoded identifier entered during manufacture, at time of purchase or distribution or transmitted by the projection system to the audience at any time including during the performance. The details of the directional signals and triggers, including complex and efficient protocols are disclosed in Fig. Px.

A preferred simplified embodiment which is representative but not limiting of the handheld part (hereinafter called the “wand”) of the present invention may be constructed from a wand having an LED 36, a receiver/discriminator logic 80 with a LED driver output, an IR sensitive phototransistor and a power source such as a small battery. This unit may be part of the event ticket, sandwiched between layers of paper, and as a button, pen, necklace, earrings or adhesive sticker, for example. An acoustic speaker 70 driven the logic 80 may be included in the wand.

The present invention substantially improves the performance and interchangeability, simplifies the manufacture, and reduces the cost of the magic wand. Concepts related to three-dimensional presentations disclosed in co-pending applications are incorporated by reference and may be applied to the inventions presented herein.

FIG. 3 present a preferred embodiment of the active display wand 30 of FIG. 2 having a handle, a supporting member, and an electro-optic assembly mounted on the elastic member, having a power source, microprocessor, one or more light emitting elements, and a cycle state indicator. One low cost and simple construction of the preferred embodiment employs a rigid plastic handle, a flexible plastic supporting member having two mounting posts and an electro-optic assembly constructed of a 3V disk battery, an low cost, 8 bit microprocessor with 512 bytes of program and data ROM, seven monochromatic light emitting diodes, a single stationary contact post and a single bendable metal wire, mounted on FP4 circuit board.

FIG. 3(a) shows a compact package with a receiver 80 mounted on the top.

FIG. 3(b) shows a compact package on a lanyard 90 with a handle 10.

FIG. 3(c) shows a compact package with an elongated connecting member 20.

FIG. 3(d) shows a volumetric sphere 92 mounted on the connecting member 20. Power 96 and power on switch may be placed in the handle 10.

FIG. 4 presents a preferred embodiment having a handle 10, a connecting member 20 and the active wand member 30 comprised of a microprocessor 32, a power source, one or more light emitting elements 36, 36′, and an activating switch mechanism 40. The obvious connections between the electronic elements are well known in the art and are not shown. All of the components are mounted on a single circuit board 38. The activating switch mechanism 40 contains a fixed contact 42, a moveable contact 44, a first post 46 affixed to the connecting member 20 and protruding through a slot 48 in the circuit board 38. In operation the circuit board 38 pivots about a second post 50 protruding from the connecting member 20 causing the first post 46 to press the moveable contact 44 onto the fixed contact 42, thus closing the electrical circuit. The closed circuit triggers the display of pattern by the light emitting elements 36, which had been programmed into the data memory of the microprocessor 32. Other known effects 70, such as audio speaker, microphone, vibrator, fog, moisture, scent, and texture and tactile response may be incorporated and controlled by microprocessor. Reference of this effects are omitted in subsequent drawings for clarity purposes only and these effects may be optionally incorporate in all subsequent presentations.

FIG. 4a presents another preferred embodiment wherein said first post 46 is conductive and in operation contacts two fixed contacts 42, 42′ closing the circuit.

FIGS. 4b and 4b′ presents another preferred embodiment wherein said first post 46 is position in an internal cutout 22 in at one end of the connecting member 22 and in operation forces moveable contact 44 against fixed contact 42.

FIG. 4c presents another preferred embodiment wherein a cam 52 in placed on second post 50 causing the moveable contact 44 against fixed contact 42.

It may be understood that the embodiments of FIGS. 4, 4a, 4b, 4c may be constructed in a manner to snap onto a protruding second post 50 with sufficient form to control the motion of the active wand member to the plane of the active wand member, or alternatively set within a cut out 22 in the connecting member 20. The connecting member 20 and the handle 10 may be of integral construction.

The connecting member 20 may be of an elastic material. Alternatively, the handle 10 may be constructed of an elastic material, including a composite including elastic foam 14 and a rigid core 16. A durable cover 12 may be applied in the form of a plastic skin.

The microprocessor may be programmed by the user through one or more switches 60, 62, 64. Various programming protocols are well known to those in the art. One preferred protocol assignees the function SET, DOT, DASH to three switches 60, 62, 64, respectively. In operation, the user holds the SET button for a proscribed amount of time, for example 5 seconds, which causes the microprocessor to enter the PROGRAM MODE, indicated by flashing one of the light emitting elements 36. The user then enters the Morse code of the letter desired using the DOT-DASH switches 62, 64 followed by the SET button.

Alternatively, holding both DOT-DASH closed for a proscribed amount of time, for example 10 sec may indicated the PROGRAM MODE, with a short time, indicating the end of the coded letter. The sequence of switches closed and time held closed may be used for other functions including but not limited to choosing display sequences, patterns, or games; on or sleep, set time in a clock wand, and general programming.

Post and internal sot

Post and base slot

Post and cover defined slot

Slot and Slot

(Programmable dot-dash-set)

FIG. 4F shows a preferred embodiment having a rotational connecting member 20 shown as a ball 26 and rod 20′ both of which may be made of elastic materials situated in a complementary socket in the handle 10. the distal end of the connecting member 20 may be retained by the handle 10 by a rotatable stop shown as an aperture 24 in the handle and a cap 22. The ball 26 may have two switch contacts 42, 42a affixed which in operation are closed by contact with conductive region 44 affixed to the socket 26a, thus providing one or more reference locations relative to the position of the handle. An audio speaker 60 and tactile element 62 such as a vibrating weight, heating element, or texture control such including surface texture and moisture may also be included in all the embodiments of the wand included in this disclosure.

FIG. 4G shows a preferred embodiment having a rotational connecting member 20 shown as a rod 20′ of elastic materials affixed at the distal end 22 to the handle 20 the active member 30 is affixed to the connecting member 20 at by means of a hook 27,1 though other well known methods of attachment may be employed.

FIG. 4H shows a preferred embodiment having an active member 30, handle 10 and connecting member 23 with a conductive region 44 electrically affixed at 41 to the active member 10 and affixed 22 to the handle 10. In operation the conductive region 44 of the connecting member 20 contacts the switch contact 42 when the active member is displaced about post 50. In FIG. 1H1 the conductive region 44 closes a circuit between switch contacts 42, 42a

Note: There is no FIG. 4I

FIG. 4J shows another preferred embodiment of the prior wands having an autostereoscopic optical component 200 and a position feedback signal 201 such as a timing sequence based on the cycle time, or absolute encoder, etc. . FIG. 1J1 shows an autostereoscopic component having a multiplicity of light emitting elements positioned as each pixel 202, 202′. FIG. 1J2 shows an autostereoscopic component having a miniature scanning mechanism 204. The scanning mechanism may be one or more resonant micromirrors, a rotating micro-prism, a resonant micro-waveguide or other scanning mechanism.

FIG. 4K shows an autostereoscopic component having a variable focal length control such as variable focal length mirror or lens 210. In operation the output of the light emitting elements 36, 36′ is focused into a distal point of varying virtual focal distance 214.

FIG. 4L shows an autostereoscopic component having a variable focal length control such as variable focal length mirror or lens. In operation the output of the light emitting elements 36, 36′ is focused into a distal point of varying virtual focal distance.

Reference and incorporation of my co-pending applications related to 3D displays in incorporated and the techniques disclosed therein may be incorporated in the present display.

FIG. 5 presents another preferred embodiment having a handle 10 set parallel to and longer than the active wand member such than when held the wand member 30 passes between the handle 10 and the center of rotation at post 50, a connecting member 20 and the active wand member 30 wherein the active wand member 30 is fully and continuous rotatable about post 50 as shown. In operation, a switching mechanism 40 detects one or more positions of the active wand member 30 relative to the connecting member 20.

FIG. 5a presents another preferred embodiment of the switching mechanism 40 having two contacts 42, 44 on the active wand member 30 which upon rotation closed a circuit by contact with a conductive region 54 on the connecting member 20. Post 50 may be rigidly affixed to the moving wand member 30

FIG. 5b presents another preferred embodiment of the switching mechanism 40 having two or more contacts 42, 44 on the active wand member 30 which upon rotation closed a circuit by contact with a conductive region 54 covering a proscribed portion of the angular surface of stationary post 50 on the connecting member 20.

FIG. 5c presents another preferred embodiment of the switching mechanism 40 having two contacts 42, 44 on the active wand member 30 which upon rotation closed by cam 52 pressing the contacts together.

FIG. 5d presents another preferred embodiment of the switching mechanism 40 having two magnetically responsive contacts 42, 44 on the active wand member 30 which upon rotation are closed by proximity to magnet 56 on the connecting member.

FIG. 6 present a coding protocol of the preferred embodiment of FIG. 2 wherein two or more angular regions 70, 72 are recognized by the microprocessor 32 based on the position or timing of the rotation of active wand member 30 and the displayed text 74, 74′ is appropriately oriented.

The active wand member 30 may be rod, plate, circle or other shape having a center of gravity 31 displaced from rotation axis on post 50. One advantage of the solid, opaque circle is that is occludes the background light.

The present invention may be used as the basis of a game of skill and perseverance including parameters such as: the duration of motion, the period, the precision of path and repeatability, the response time to presented images. Moving images and text may be presented. Players may be required to decode obscure images, match images in space, synchronize or repeat movements.

FIG. 7 presents a fan disk embodiment of the present invention, which may be fixed to handle or free flying as a solid Frisbee. The active wand elements include those previously referenced. The light emitting elements 36, the microprocessor 32 are shown with one or more magnetic field sensors 110, 110′ such as Hall effect devices, incorporated to detect an external magnetic field such as the earth's natural field as a position reference for free flight. The light emitting elements 36 may employ light pipes 116 such as fiber optic channels to transfer the exit aperture to the perimeter top, bottom or side.

FIG. 7a shows an encoded precession based on the number of periods or cycles of the image 114 in the present invention. When the full cycle precession period is greater than 2 seconds, viewers at all radially positions will observe the full scanning image.

FIG. 8 shows a rotatable display having the aforementioned components in FIG. 3 where the center of gravity 31 may be displaced from the center of rotation post 50 be a swinging motion to position 31′ by displacing an elastic mass 33 to position 33′. Rotational energy may be stored by one or more rotational masses 33 which may be distributed in any symmetrical or asymmetrical manner about the center of rotation.

FIG. 8a shows a mass 33 on a spring 33a to store energy.

FIG. 8b shows a deformable gel as an method for storing energy

Other methods known in the art of rotational energy storage may be employed, including electrical, chemical, pneumatic, hydraulic and various mechanical approaches

FIG. 9 shows a preferred embodiment of the projector unit 90 of the present invention where the controlling processor 100 receives input from the musical instruments 102, a MIDI or data channel 104, or other source 106 such as a manual operator, voice control, etc. The pattern 96 may be a simultaneously projected image or scanned beam 98, 98′, modulated both temporally and spatially. Any wavelength, visible, IR or UV (black light) may be used as the signal carrier, which may include a carrier frequency to differentiate from background optical noise. The pattern may include a programmed data sequence received and stored by each wand 30. The data may be automatically triggered at a later time internally, or by a second acoustic, optical, motion, magnetic or radio frequency signal.

An infrared projector with both directional and omnidirectional modes modulates a signal with a carrier frequency of 36 KHz or less which may be used to for simple commands, or a higher frequency for more complex transmissions. Standard digital IR communications protocols may be also employed.

In the simplest mode of operation, the wands are identical and distributed to the audience in any manner. The projector transmits a spatially and temporally controlled signal which activates the wand correspondingly. A more complex logic permits the transmission of an spatially modulated identity signal to the wands in a specific location, which “fixes” their responses to subsequent commands. One example would be the transmission of an spatially modulated identity signal of 5 seconds duration, followed by an activation signal of 100 milliseconds. Another example would be the spatially modulated transmission of a digital identity code which each wand would retain. Under these circumstances, the audience could move about with the wands retaining their original location information.

The utility of transmitting a spatially modulated digital identity code is manifold: it permits the wands to be uniform during manufacture and distribution, it automatically corrects for errors in seating plans, and allows games to be developed based on the location of the participants at a given time.

The visual effects of a digitally encoded identity and program are extensive. Real time response permits moving images without flicker effects if desired. Complex optical effects may also be incorporated. Once the digital program is downloaded to the specified wands, the mechanism of initiating the program sequences may be global or localized, augmented by other transmitting media as well, such as acoustic (tied to a specific frequency or sequence in a song), ultrasound, radio frequency, tactile ( a switch) or environmental (temperature, wind, motion, etc.).

In addition, the acoustic effects when the wand incorporates an audible speaker have utility. In a concert, the audience becomes an instrument, controlled by the band, having fill control of the timing, location, frequency and volume of each wand. Three-dimensional and interference effects are clear benefits from the precise temporal control and spatial distribution.

The control system or control board may resemble an instrument, such as a synthesizer keyboard or other integration of existing controls including electronic guitars, wind and percussion musical devices. Thus, one may integrate the visual and/or audio control of the wands into the live music performance.

FIG. 10 shows a preferred embodiment of the audio control 102 of the projector unit 90 of the present invention where the controlling processor 100 receives input from a keyboard type musical instruments 102 with regional controls r1u, r1l, r2u, . . . corresponding to audience locations R1u . . . /

FIG. 11 shows a partial schematic diagram of projector-receiver trigger system with a carrier modulated signal 98 and a corresponding discriminator circuit 34 in the electronics of the display wand 30. For illustration purposes, the embodiment shown also employs a directional scanner 112 though either scanning, image projection or global trigger embodiments may be used.

When using infrared signals there exists the problem of interference from other IR sources. A simple method to eliminate these effects is to modulate the carrier beam within a specified frequency range. By employing a discriminator circuit 34 which may be an analog bandpass circuit, a software routine or other known technology, the present invention may be used without error in common venues such as outdoor arenas, sports stadiums, theatres and clubs.

FIG. 12 shows a partial schematic diagram of projector-receiver trigger system using a chromatic signal and employing an optical bandpass filter 122 on the receiver circuit. Another embodiment of the present invention employs a specific wavelength of radiation including visible light which is not intense in the standard venues where most illumination sources have irregular spectral distributions. The bandpass filter may utilized any known optical bandpass technology including but not limited to a simple colored gel or more sophisticated interference filter.

FIG. 13 shows a block diagram of projector-receiver ID trigger system. Each receiver 30 is transmitted an identifying code “ID” 98, 98′ and/or program based on the receiver's location at the time of transmission. A second code, either transmitted to the same or a different receiving circuitry 80′ acts as a trigger, to initiated the previously transmitted or encoded program. The trigger signal may be optical, electromagnetic, RF, global, ultrasonic, acoustic, temperature, wind or even olfactory. These technique may be employed to transmit a program which will automatically commence at a fixed time after the transmission, seconds or days, or in response to external events including an action of the audience utilizing input devices, switches 42, 44, optic or acoustic receivers 80 on the display wand 30.

FIG. 14 shows a perspective view of an image projector 90 embodiment of the present invention where a spatial modulator 142 is utilized to impart directionality to the carrier frequency modulated signal 98 emitted by the signal source 140. An intermediate modulator 142′ may be employed to impart the carrier frequency. The spatial modulator may be a digital micromirror device, a liquid crystal shutter matrix, an acousto-optic modulator or other known modulator technology.

FIG. 15 shows a perspective view of a scanning projector embodiment of the present invention where one or more narrow modulated beam 98 is scanned across the audience. The projector source 152 may be a matrix of laser diodes, LEDs or other electronically modulated emitter source. Alternatively, the modulator may be a micromirror device, a liquid crystal shutter matrix, an acousto-optic modulator or other known modulator technology. The scanning optics may be mechanical such as a motor 154, electro or acousto-optic, or other know scanning technology.

### SUMMARY OF PREFERRED EMBODIMENTS

Wand

Simple

With LED

With Audio Speaker

With Motion trigger

With vibrating and other tactile effects

Producing smoke, moisture, change of temperature.

Receiving for data or trigger IR, UV, ultrasound, RF, EMF, visible light, audible sound

carrier signal

simple on off

modulated to remove interference

with data

with timer

carrier wavelength

IR

Visible

Visible modulated a non visible frequency

Black Light (UV)

AO

RF

Projector

Full frame

Vector scan

Raster scan

Line scan

Static (audience or starts move in and out of range)

Controller

Pre programmed

Live

Connected to musical instruments

Connected to movement

Mask

Resembling a Synthesizer Keyboard or other musical instrument

Resembling a Lightboard

Videotape, DVD, CD, etc.

Game Embodiment of the Present Invention

The present invention may be the basis of a complex public game using general spaces and the Internet.

FIG. 16 presents a conceptual block diagram of the receiver embodiment of the present invention. Each wand receives a unique identification code during manufacture or sale. A series of projectors transmit a game code in each venue. The incorporated receiver registers the code when the wand “visits” the projector space.

In another preferred embodiment, the receiver 80 in the wand recognizes a pattern presented on an Internet site and stores a transmitted code. Wands containing the code are activated by a signal projected by projector 90 in the activating venue displaying a pattern on the light emitting elements or a sound. It may be understood that the wand of the present invention may also contain a audio input/output, a motion detector and/or vibration mechanism as is found in cell phone and beepers. The venue may be a concert, fair, celebration, ceremony, shopping mall, store or other location. One advantage of the present invention is its low cost of manufacture and implementation.

In another preferred embodiment, the light emitting elements 36 may act as a transmitter, sending data or signals to proximal wands as part of the game.

Unique elements of the game are:

One or more projectors

One or more receivers

Transceiver

Each unit with a unique ID

IntraWand transmission-

Internet Communication-

Using IR

Scan Image—On-Off at reasonable speeds on any monitor—The game may employ the Internet providing a visual scannable image or data on any Internet monitor of in response the transmission of specific data by the user. Maps, clues and other instructions may be provided. In a more sophisticated version, GPS (global positioning satellite) interfaces may be employed.

Unit programmable using 2 or more button Morse code (dot, dash, hold both to set) or other code.

The data received by the wand from the projector, together with the motion and or response of wand during the performance or operation by the user, may be retained permanently in the wand memory (OTP, flash, battery backed, smart card, etc.) or for a predetermined period of time. This information may include music in MP3 and other formats. The combination of data plus activity may be used as a basis for awards and prizes. For example, a different data combination (abstract, visual, audio or other format) may be download at each performance if the user is seated within the first ten rows. Collecting all the combinations from a tour may entitled a person to a “back stage” pass on the next tour.

The present invention may incorporate the three dimensional visual display systems of my prior and co-pending U.S. patent applications.

FIG. 17 presents a top view of the preferred viewframe registration embodiment of the present invention. Although handheld or independent placed wands may be generally positioned by the user, an improvement in the global viewframe registration of the displayed pattern of each wand may be accomplished by providing a reference point. This reference point 102 may be established by transmitting one or more direction beams which are recognized by a wand viewframe reference system 110 in each of the wands 30. The reference system 110 recognizes the angular direction to the reference point 102 in relation to the centerpoint 112 of the wand and generates a centerpoint offset 114. The centerpoint offset 114 is used by the display electronics 32 to shift or adjust the pattern displayed by wand emitting elements, such as 202, 202′, varifocal optics 210, or scanner 204.

The orientation of the display wand pattern is important in an horizontal parallax autostereoscopic system. Generally, the normal positioning of handheld or mounted wands obviates the requirement for an orienting system. However in certain applications, such as a thrown or rolling ball, balloon or free swing wand, the dynamic adjustment of the displayed pattern to the immediate orientation is desirable.

A gravity sensor, such free rotating offset mass, MEMS arm, or other known technology may be integrated with the viewframe, location and data receivers to provide global oreientatino to the displayed pattern.

FIG. 18 presents a detailed top view of a single wand 30 for a reference system 110 using a omnidirectional point source reference point 102 and a wand reference system 110 having the two analog photodetectors 122, 124 and an controlled dispersive element 130 which transforms the reference point beam 104 into a defined spatial pattern such as but not limited to a gaussian energy distribution 130. The energy levels received at the photodetectors 122, 124 may be compared and an offset 114 generated from the known energy distribution and the photodetector levels.

The orientation of the display wand pattern is important in an horizontal parallax autostereoscopic system. Generally, the normal positioning of handheld or mounted wands obviates the requirement for an orienting system. However in certain applications, such as a thrown or rolling ball, balloon or free swing wand, the dynamic adjustment of the displayed pattern to the immediate orientation is desirable.

FIG. 19 presents a persceptive view of a reference system 110 having two offset reference points 102, 102′ and three analog photodetectors 122, 124, 126. By comparing the relative energy levels of the three photodetectors, the spatial orientation of the wand 30 may be determined. A more detailed orientation may be achieved by differentiating the reference points 102, 102′ by modulating the cycles such as turning one point on for 5 milliseconds and the second for 10 milliseconds, using different radiative spectra, or encoding the signal. A multiplicity of detectors may be Iused to increase resolution.

In a system where the data receiver 80 and reference system 110 are separate, a coordinating signal may be sent to the data receiver.

FIG. 20 presents the use of a global reference such as the ambient or earth's magnetic or gravitional field to provide a wand orientation. The circuit 310 may be programmed to reference the maximum, minimum or other phase of the field. The orientation reference 300 is then used to properly shift the displayed pattern relative to the image position of the receiver.

It may be understood that the viewframe reference system may utilize visible or non-visible radiation including but not limited a constant, scanned or modulated beam of visible, uv, infrared light, microwave or radio frequencies. Propagation timing using light, radio frequencies, sonic or ultrasonic wave may also be used, as well as interference patterns.

As is shown in recently issued US Patent related to autostereoscopic wands, the autostereoscopic effects module or wand may employed a multiplicity of technologies. All of the embodiments shown therein may be incorporated in the present application.

The embodiment of the invention particularly disclosed and described herein above is presented merely as an example of the invention. Other embodiments, forms and modifications of the invention coming within the proper scope and spirit of the appended claims will, of course, readily suggest themselves to those skilled in the art.

What I claim is:

1. A projector and wand receiver system comprising:
a) a control board having means to transmit a series of commands to a projector,
b) said projector having means to receive said commands from said control board and having means to project at least one directional signal to at least one of a plurality of wand receivers,
c) said wand receiver having means to receive said signal and emit a designated response.

2. A projector and wand receiver system as specified in claim 1 wherein said wand receiver means for emitting a designated response further includes at least one light and means for powering said light.

3. A projector and wand receiver system as specified in claim 1 wherein said wand receiver means for emitting a designated response further includes at least one audio speaker and means for powering said speaker.

4. A projector and wand receiver system as specified in claim 1 wherein said projector further includes means for scanning all of a plurality of wand receivers within 100 milliseconds.

5. An autostereoscopic performance effects systems comprising:
a) a control board having means to transmit a series of commands to a projector,
b) said projector having means to receive said commands from said control board and having means to project at least one directional signal to at least one of a plurality of wand receivers,
c) said wand receiver having means to receive said signal and emit a designated response
d) said wand displaying a pixel of autostereoscopic pattern.

6. An autostereoscopic performance effects systems in accordance with claim 6 wherein said wand further includes means to shift said autostereoscopic pattern in relation to the orientation of the wand.
